(19) United States
(12) Patent Application Publication
(10) Pub. No.: US 2011/0095585 A1
(43) Pub. Date: Apr. 28, 2011

(54) VEHICLE SEAT DEVICE (AS AMENDED)

(76) Inventors: Hideyuki Kato, Aichi (JP); Takahiro Sugama, Aichi (JP); Mikihito Muramatsu, Aichi (JP)

(21) Appl. No.: 12/674,462

(22) PCT Filed: Sep. 6, 2007
(86) PCT No.: PCT/JP2007/067409

§ 371 Date: Jan. 4, 2011

(51) Int. Cl. B60N 2/30

(52) U.S. Cl. 297/344.1

(57) ABSTRACT

The invention provides a vehicle seat device including fewer restrictions with respect to seat function and which can be switched from a seating position to a storage position by motive power. In a vehicle seat (10), a vehicle width direction outer side end portion of a seat cushion (12) is supported so as to be capable of rotating around a drive shaft (30) having an axis along a vehicle front-rear direction, and the seat cushion can be switched between a seating configuration at which an occupant can be seated and a storage configuration at which the seat cushion (12) stands erect along a vehicle cabin inner side surface S, due to rotating around the drive shaft (30). A drive motor (42) is fixed to a vehicle body floor F at an installation side of the rotation shaft (30) with respect to a vehicle width direction center portion of the seat cushion (12), the drive motor (42) switching the seat cushion between the seating position and the storage position due to rotation of the drive shaft (30) that is fixed to the seat cushion (12).

### TECHNICAL FIELD

The present invention relates to a vehicle seat device which is mounted at a vehicle such as, for example, an automobile or the like, and which can be switched between a seating position and a storage position by motive power.

### RELATED ART

A technology is known in which a seat cushion frame and a rotating rod are supported on a base bracket so as to be respectively rotatable about different axes that are mutually parallel and where a portion of the seat cushion frame different from the axis is linked, such that it may freely rotate, to a gear box that can move linearly on the rotating rod, whereby a revolving slider mechanism where the base bracket serves as a fixed link is configured, the gear box is driven by a motor, and the seat cushion is automatically tipped up in a vehicle body side direction (e.g., see Patent Document 1). Patent Document 1 is Japanese Utility Model Application Laid-Open No. 5-54065, Patent Document 2 is Japanese Patent Application Laid-Open (JP-A) No. 2003-212012.

### DISCLOSURE OF THE INVENTION

### Problem to be Solved by the Invention

However, in the prior art as described above, the driving device (particularly the motor) is disposed inside the seat cushion frame, so there has been the problem that this lowers the degree of freedom of the seat layout.

In consideration of the above-described circumstances, it is an object of the present invention to provide a vehicle seat device including fewer restrictions with respect to seat function and which can be switched from a seating position to a storage position by motive power.

### Method of Solving the Problem

A vehicle seat device according to a first aspect of the present invention comprises: a seat cushion that is supported so as to be rotate about a rotation shaft having an axis along a vehicle body front-rear direction at a vehicle width direction outside end portion thereof, and which can be switched between a seating position at which an occupant can be seated and a storage position at which the seat cushion stands erect along a vehicle body inner surface, due to rotation around the rotation shaft; and driving means including a drive source that is fixed to a vehicle body on an installation side of the rotation shaft with respect to a vehicle width direction center portion of the seat cushion of the vehicle body and a vehicle body up-down direction lower portion, the driving means switching the seat cushion between the seating position and the storage position by activation of the drive source.

According to the above aspect, for example, when the seat cushion is switched to the storage position from the seating position at which seating of an occupant is possible, the driving means is operated. When this is carried out, the seat cushion rotates around the rotation shaft and is switched to the storage position at which the seat cushion stands erect along the vehicle body inner surface, due to the motive power of the driving means. Further, for example, when the seat cushion is switched from the storage position to the seating position, a drive source of the driving means is operated. When this is carried out, the seat cushion rotates around the rotation shaft and is switched to the seating position in which it is along a vehicle body floor surface, due to the motive power of the driving means.

Here, the drive source of the driving means is fixed to the vehicle body on the rotation shaft side (vehicle width direction outer side) with respect to the vehicle width direction center of the seat cushion, whereby a situation where the drive source occupies space inside the seat cushion (frame) and imparts restrictions on the seat functions (layout) is avoided. Further, the drive source is positioned on the vehicle body lower portion, so the driving means and the seat cushion can always be connected such that motive power for switching configurations is transmittable. Because of this, it becomes possible for the seat cushion to be switched between the seating position and the storage position by just the vehicle occupant operating a switch, for example.

In this manner, in the vehicle seat device according to the above-described aspect, can be switched from the seating position to the storage position by motive power including fewer restrictions with respect to seat function. It will be noted that “vehicle body up-down direction lower portion of the vehicle body” means a position in the vehicle body up-down direction where the drive source and the rotation shaft can be connected so as to not become a seating hindrance; for example, this can be a position where an output portion of the drive source is the same height as or lower than the upper end of the seat cushion.

In the preceding aspect, a configuration may be provided wherein the rotation shaft is provided so as to rotate integrally with the seat cushion, and the driving means is configured an output shaft thereof connected to the rotation shaft so as to rotate integrally with the rotation shaft when the output shaft rotates by activation of the drive source.

According to the preceding aspect, the driving means is configured by just the drive source, and when this drive source is activated, the rotation shaft rotates integrally with the seat cushion and the seat cushion is switched between the seating position and the storage position. In this manner, the rotation shaft is directly rotated by the drive source, so space that a motive power transmission mechanism or the like (an element other than the drive source of the driving means) occupies inside the seat cushion becomes unnecessary, and restrictions with respect to seat function become even fewer. It will be noted that, as the drive source that is activated and whose output shaft is caused to rotate, there can be used a reducer-equipped motor or the like, for example. Further, the output shaft of the drive source and the rotation shaft may also be configured integrally.

In the above aspect, a configuration may be provided wherein the drive source is disposed behind the seat cushion in the vehicle body front-rear direction.

According to the preceding aspect, the drive source is disposed behind the seat cushion, or in other words the drive source does not occupy space inside the seat cushion, so restrictions with respect to seat function become even fewer. Further, interference between the seat cushion (the locus of displacement between the seating position and the storage position thereof) and the drive source does not occur, whereby restrictions with respect to the layout and disposition of the seat are reduced.

In the above aspect, a configuration may be provided wherein the drive source is fixed to a support member that is fixed to a vehicle body floor and supports the rotation shaft or the output shaft such that it is able to freely rotate with respect to the vehicle body.

According to the preceding aspect, the seat cushion, the rotation shaft, the support member and the drive source can be made into an assembly such that they can be handled integrally when mounting them in the vehicle body. Because of this, mountability in a vehicle body is fine even while the seat has a configuration where the driving means (drive source) is disposed on the vehicle body.

In the above aspect, a configuration may be provided wherein the portion of the rotation shaft that supports the vehicle body front-rear direction front side of the seat cushion and the portion of the rotation shaft that supports the vehicle body front-rear direction rear side of the seat cushion are divided in the vehicle body front-rear direction.

According to the preceding aspect, interference between the seat cushion (the locus of displacement between the seating position and the storage position thereof) and the drive source does not interfere in the portion between the plurally divided rotation shafts, so restrictions with respect to the layout and disposition of the seat become fewer.

### EFFECT OF THE INVENTION

As described above, the vehicle seat device according to the present invention has the excellent effects that the vehicle seat device can be switched from a seating position to a storage position by motive power including fewer restrictions with respect to seat function.

### BRIEF DESCRIPTION OF THE DRAWINGS

FIG. 1 is a perspective view showing a seating position of a vehicle seat according to a first exemplary embodiment of the present invention;

FIG. 2 is a perspective view showing a storage position of the vehicle seat according to the first exemplary embodiment of the present invention;

FIG. 3 is a side view showing the vehicle seat according to the first exemplary embodiment of the present invention as seen from a vehicle width direction outside;

FIG. 4 is a rear view of the vehicle seat according to the first exemplary embodiment of the present invention;

FIG. 5A is a plan view schematically showing a drive mechanism of the vehicle seat according to the first exemplary embodiment of the present invention;

FIG. 5B is a rear view schematically showing the drive mechanism of the vehicle seat according to the first exemplary embodiment of the present invention;

FIG. 6A is a plan view schematically showing a drive mechanism of a vehicle seat according to a second exemplary embodiment of the present invention;

FIG. 6B is a rear view schematically showing the drive mechanism of the vehicle seat according to the second exemplary embodiment of the present invention;

FIG. 7A is a plan view schematically showing a drive mechanism of a vehicle seat according to a third exemplary embodiment of the present invention;

FIG. 7B is a rear view schematically showing the drive mechanism of the vehicle seat according to the third exemplary embodiment of the present invention;

FIG. 8A is a plan view schematically showing a drive mechanism of a vehicle seat according to a fourth exemplary embodiment of the present invention;

FIG. 8B is a rear view schematically showing the drive mechanism of the vehicle seat according to the fourth exemplary embodiment of the present invention;

FIG. 9A is a plan view schematically showing a drive mechanism of a vehicle seat according to a fifth exemplary embodiment of the present invention;

FIG. 9B is a rear view schematically showing the drive mechanism of the vehicle seat according to the fifth exemplary embodiment of the present invention;

FIG. 10A is a plan view schematically showing a drive mechanism of a vehicle seat according to a sixth fifth exemplary embodiment of the present invention;

FIG. 10B is a rear view schematically showing the drive mechanism of the vehicle seat according to the sixth fifth exemplary embodiment of the present invention;

FIG. 11A is a plan view schematically showing a drive mechanism of a vehicle seat according to a reference example that is not included in the present invention; and

FIG. 11B is a rear view schematically showing the drive mechanism of the vehicle seat according to the reference example that is not included in the present invention.

### BEST MODE OF IMPLEMENTING THE INVENTION

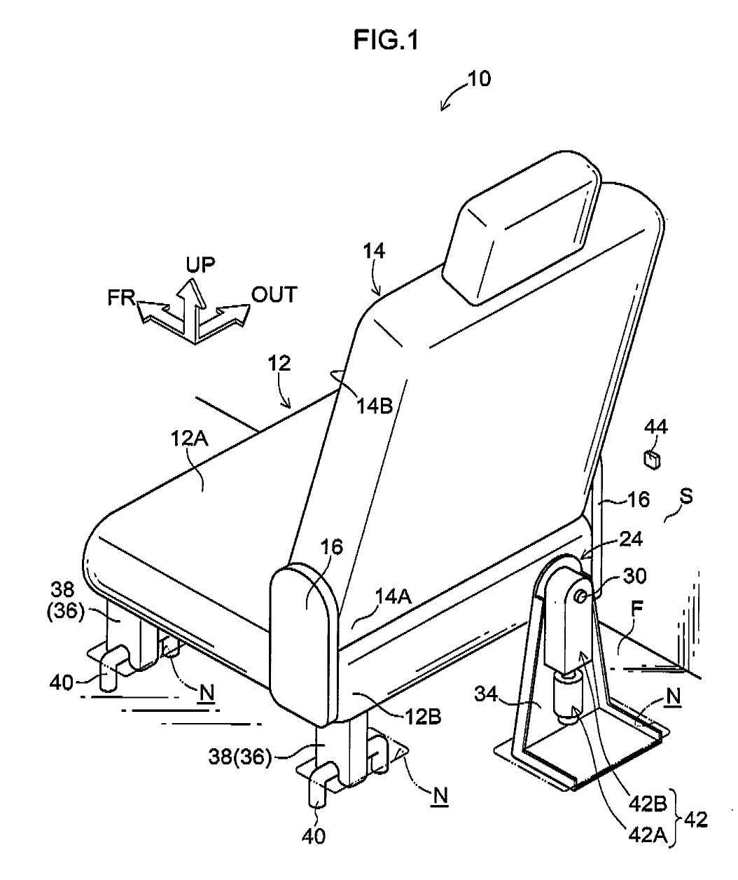

A vehicle seat 10 serving as a vehicle seat device according to a first embodiment of the present invention will be described on the basis of FIG. 1 to FIG. 5. It will be noted that arrow FR and arrow UP appropriately indicated in the drawings respectively represent a frontward direction (traveling direction) and an upward direction of an automobile to which the vehicle seat 10 is applied and that arrow OUT represents the outside in a vehicle width direction that coincides with a seat width direction.

In FIG. 1, the general overall configuration of the vehicle seat 10 is shown in a perspective view. As shown in this drawing, the vehicle seat 10 has a seat cushion 12 for seating a vehicle occupant of the automobile in which the vehicle seat 10 has been mounted and a seat back 14 that is connected to the rear end of the seat cushion 12 and is for supporting, from behind, the upper body of the seated vehicle occupant. This vehicle seat 10 is a third row seat (third seat).

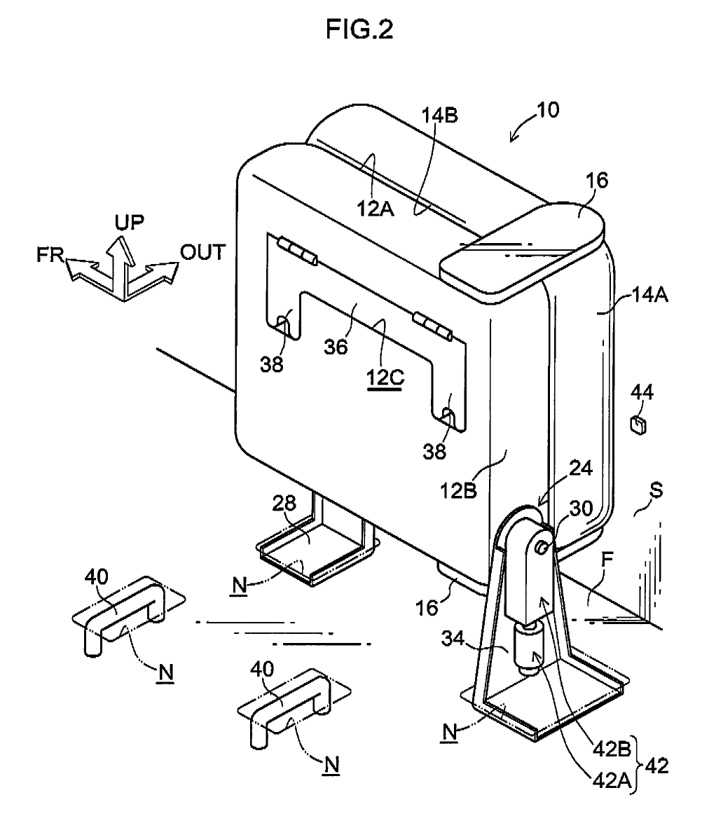

This vehicle seat 10 is given a configuration where it can be switched between a seating position (see FIG. 1) where a seating surface 12A of the seat cushion 12 faces up in the vehicle body up-down direction to enable seating of the vehicle occupant and a storage position (see FIG. 2) where the seat cushion 12 is tipped up in the vehicle body side direction and stands upright along a vehicle cabin inside surface S. The vehicle seat 10 will be described specifically below.

As shown in FIG. 1 and FIG. 2, a lower end portion 14A of the seat back 14 is tiltably connected to a rear end portion 12B of the seat cushion 12 via a reclining device 16. The reclining device 16 enables the seat back 14 to be forwardly tilted until a state where the seat back 14 is superposed on top of the seat cushion 12 (hereinafter called a fold-up state) so that a back rest 14B of the seat back 14 becomes overlaid on the seating surface 12A of the seat cushion 12. This reclining device 16 is equipped with unillustrated biasing means (spiral springs) that biases the seat back 14 in the forwardly tilting direction with respect to the seat cushion 12 and a lock mechanism that holds the seat back 14 in an arbitrary tilt position (inclination angle) with respect to the seat cushion 12.

Because of this, the vehicle seat 10 is given a configuration where, when a load is not placed on the seat back 14 in a lock release state of the lock mechanism, the seat back 14 is forwardly tilted with respect to the seat cushion 12 by the biasing force of the biasing means and is placed in the fold-up state. When a rearward load that exceeds the biasing force acts on the seat back 14 in the lock release state, the seat back 14 is backwardly tilted with respect to the seat cushion 12.

Further, in this embodiment, there is disposed an electrically-powered reclining lock release device, and the locked state of the reclining device 16 is automatically released by operation of a later-described switching switch 44. Because of this, there is realized a configuration where, when the switching switch 44 is operated in a state where no vehicle occupant is seated in the vehicle seat 10, the seat back 14 is placed in the fold-up state where it is superposed on top of the seat cushion 12.

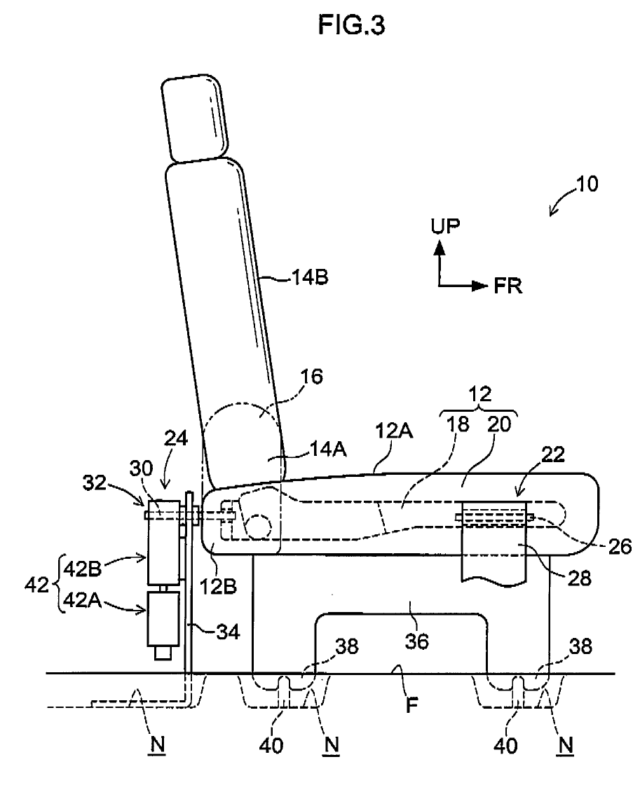

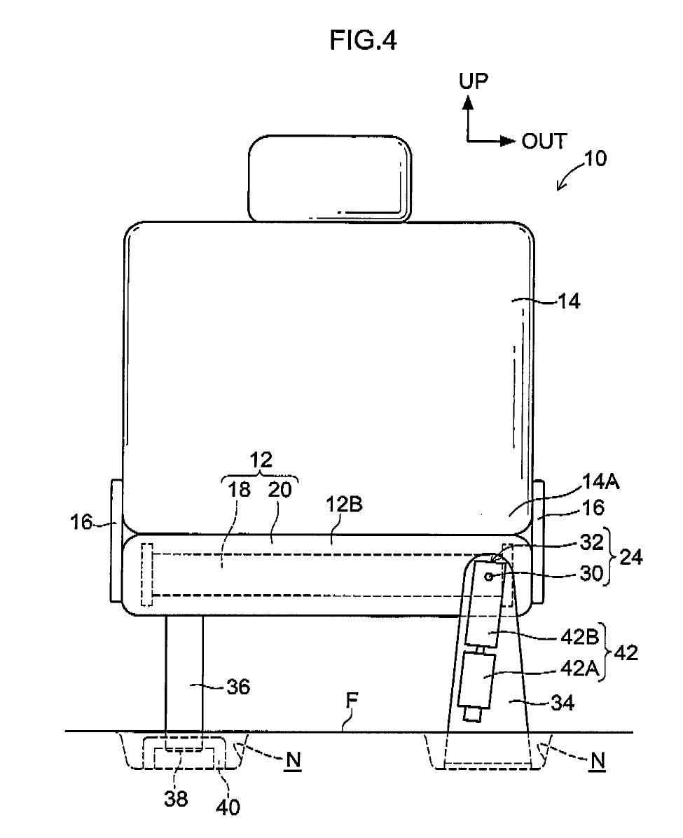

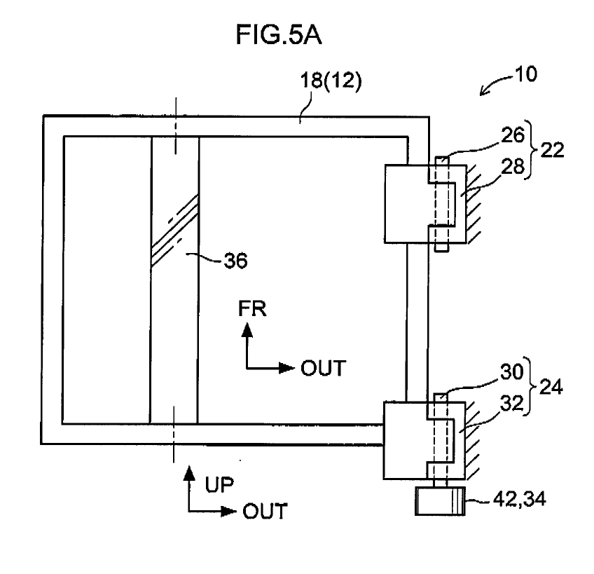

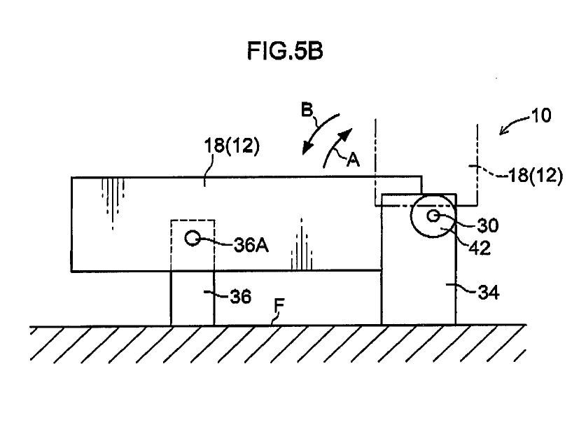

As shown in FIG. 3 and FIG. 4, the seat cushion 12 is configured as a result of a cushion material 20 being provided at a seat cushion frame 18. As shown in FIG. 3 and FIG. 5(A), the seat cushion frame 18 is supported so as to be rotatable about an axis along the vehicle body front-rear direction with respect to the vehicle body via a front hinge 22 and a rear hinge 24 that are disposed on a vehicle width direction outside end portion of the seat cushion frame 18. The front hinge 22 is configured to include a driven shaft 26, which is arranged longitudinally in the vehicle body front-rear direction and is fixed at the seat cushion frame 18, and a front hinge bracket 28, which supports the driven shaft 26 so as to be capable of rotating around the axis thereof. A lower end portion of the front hinge bracket 28 is fixed to a vehicle body floor F.

The rear hinge 24 is configured to include a drive shaft 30, whose front-rear direction is in the vehicle body front-rear direction and which is fixed to the seat cushion frame 18, and a rear hinge bracket 32, which supports the drive shaft 30 such that the drive shaft 30 is rotatable about its axis. The rear hinge bracket 32 is fixed to the vehicle body via a base bracket 34 serving as a support member whose lower end is fixed to the vehicle body floor P. The drive shaft 30 is disposed coaxially with the driven shaft 36, and the seat cushion frame 18 (the seat cushion 12) is given a configuration where it can switch between the seating position and the storage position by rotating about the axis of the driven shaft 26 and the drive shaft 30.

Further, a support leg 36 is provided at the vehicle width direction inside of the vehicle width direction center portion of the seat cushion frame 18. The support leg 36 has a pair of front and rear floor lock portions 38, and each floor lock portion 38 has an unillustrated lock member that is capable of locking to and unlocking from a seat anchor 40 fixed to the vehicle body floor F. Additionally, the floor lock portions 38 are given a configuration where the lock members of the floor lock portions 38 become latched (locked) to the seat anchors 40 in the seating position of the vehicle seat 10 and switching the vehicle seat 10 from the seating position to the storage position is allowed by releasing the locking of the lock members with respect to the seat anchors 40.

In this embodiment, there is an electrically-powered seat lock release device, and the latching of the floor lock portions 38 with respect to the seat anchors 40 is automatically released by operation of the later-described switching switch 44. Further, the lock members are biased in the locking direction by unillustrated baising means, are displaced in the lock releasing direction by being pushed against the seat anchors 40, and mechanically move to the locked state with respect to the seat anchors 40 in accompaniment with the switching from the storage position to the seating position.

It will be noted that the seat anchors 40 are respectively laid inside recessed portions N that are provided in the vehicle body floor F (floor panel). Because of this, the seat anchors 40 are given a configuration where they do not project from the vehicle body floor F in the storage position. Further, the lower end portion of the front hinge bracket 28 and the lower end portion (fastening site) of the rear hinge bracket 32 are also laid inside recessed portions N. Moreover, the support leg 36 is supported such that it may freely rotate about a support shaft 36A (see FIG. 5(B)) along the vehicle body front-rear direction with respect to the seat cushion frame 18, and as shown in FIG. 2, in the storage position, the support leg 36 is housed in a leg housing portion 12C in the seat cushion 12 such that the support leg 36 becomes a substantially even surface with respect to the vehicle width direction inward-facing surface (the undersurface in the seating position) of the seat cushion 12.

Additionally, the vehicle seat 10 comprises a drive motor 42 serving as driving means and a drive source for switching the seat cushion 12 between the seating position and the storage position. The drive motor 42 is a reducer-equipped motor (motor actuator) including a motor portion 42A and a gear portion 42B. In this embodiment, the rear hinge bracket 32 that is fixed to the base bracket 34 doubles as a gear housing that configures the gear portion 42B, and the drive shaft 30 doubles as an output shaft of the gear portion 42B. That is, in this embodiment, the rotation shaft in the present invention and the output shaft in the present invention are integrated.

Because of the above, the drive motor 42 is configured such that the gear portion 42B directly drives the drive shaft 30 to rotate when the motor portion 42A is activated. It will be noted that the motor portion 42A is disposed under the gear portion 42B in the vehicle body up-down direction and on the back surface side of the base bracket 34.

Further, the drive motor 42 is configured to be capable of forward and reverse rotation, forwardly rotates to cause the drive shaft 30 (the seat cushion frame 18) to rotate in the direction of arrow A (see FIG. 5(B)), and reversely rotates to cause 30 to rotate in the direction of arrow B (see FIG. 5(B)), which is the opposite of arrow A. Because of this, the seat cushion 12 is switched from the seating position to the storage position by forwardly rotating the drive motor 42 and is switched from the storage position to the seating position by reversely rotating the drive motor 42. Although it is not shown in the drawings, the drive motor 42 (and the base bracket 34) is covered by a cover member.

Moreover, in the vehicle seat 10, the drive motor 42, the electrically-powered reclining lock release mechanism, the electrically-powered seat lock release mechanism and the switching switch 44 are electrically connected to an unillustrated control circuit (or ECU) serving as a control device. The control circuit is configured to respectively activate the electrically-powered reclining lock release mechanism and the electrically-powered seat lock release mechanism and thereafter drive the drive motor 42 to forwardly rotate when an operation signal is inputted to the control circuit from the switching switch 44 in a state where the vehicle seat 10 is to assume the seating position. The control circuit is also configured to drive the drive motor 42 to forwardly rotate when an operation signal is inputted to the control circuit from the switching switch 44 in a state where the vehicle seat 10 is to assume the storage position.

It will be noted that the control circuit is configured to judge whether the configuration of the vehicle seat 10 is the seating position or the storage position on the basis, for example, of a lock signal that is inputted to the control circuit from the electrically-powered seat lock release mechanism when the lock members of the floor lock portions 38 are locked to the seat anchors 40 or on the basis of an unlock signal that is inputted to the control circuit from the seat lock release mechanism when the lock members of the floor lock portions 38 are free.

As shown in FIG. 1, the switching switch 44 is disposed behind the vehicle seat 10 (the seat back 14) on the vehicle cabin inside surface S and is configured to be operable from a rear gate of the vehicle body. It will be noted that, in addition to this switching switch 44 or instead of this switching switch 44, the switching switch 44 can also, for example, be disposed in the vicinity of the driver seat or the like.

The automobile to which the vehicle seat 10 described above is applied comprises another vehicle seat 10, which is configured substantially symmetrically with the vehicle seat 10 with respect to a vehicle width direction centerline of the vehicle body. The vehicle seat 10 and the other vehicle seat 10 are given a configuration where they can be independently switched between the seating position and the storage position.

Next, the operation of the first embodiment will be described.

In the vehicle seat 10 of the above-described configuration, seating of a vehicle occupant is enabled in the seating position shown in FIG. 1, When this vehicle seat 10 is to be stored, the switching switch 44 is operated. When this happens, the control circuit activates the electrically-powered reclining lock release mechanism such that the locked state of the reclining device 16 is released. Because of this, the seat back 14 is folded up on the seat cushion 12 by the biasing force of the biasing means. Further, the control circuit activates the electrically-powered seat lock release mechanism such that the locked state of the floor lock portions 38 is released.

Next, the control circuit outputs a forward rotation command to the drive motor 42. When this happens, the drive motor 42, which is fixedly supported on the vehicle body floor F, forwardly rotates and causes the drive shaft 30 to rotate in the direction of arrow A with respect to the vehicle body. The seat cushion 12 is rotated by this drive force in the direction of arrow A with respect to the vehicle body together with the folded up seat back 14 and reaches the storage position as shown in FIG. 2. Because of this, in the automobile in which the vehicle seat 10 is mounted, a wide cargo space can be ensured when the third seats are not in use.

hen the vehicle seat 10 is to be switched from the storage position to the seating position, the switching switch 44 is operated. When this happens, the control circuit outputs a reverse rotation command to the drive motor 42, and the drive motor 42 reversely rotates and causes the drive shaft 30 to rotate in the direction of arrow A. The seat cushion 12 is rotated by this drive force in the direction of arrow B with respect to the vehicle body together with the folded up seat back 14 and reaches the seating position of the seat cushion 12. In accompaniment with this operation, the floor lock portions 38 become locked to the seat anchors 40. The vehicle occupant manually releases the lock of the reclining device 16, raises the seat back 14, and becomes seated in the vehicle seat 10.

Here, in the vehicle seat 10, because the vehicle seat 10 comprises the drive motor 42, the vehicle seat 10 (the seat cushion 12) can be automatically switched from the seating position to the storage position by operation of the switching switch 44. Further, the seat cushion 12 can be automatically switched from the storage position to the seating position by the drive motor 42. Because of these, the vehicle occupant can change the seat arrangement without expending effort.

Additionally, in the vehicle seat 10, the drive motor 42 is fixed to the width direction outside portion of the seat cushion 12 in the vehicle body floor F, so the drive motor 42 does not occupy space inside the seat cushion frame 18. In particular, in the vehicle seat 10, the drive motor 42 is disposed behind the seat cushion 12, so the drive motor 42 does not occupy any space inside the seat cushion frame 18. Moreover, the drive motor 42 directly drives the drive shaft 30, so a mechanism that connects the drive motor 42 and the drive shaft 30 such that motive power is transmittable is unnecessary, and a motive power transmission mechanism is also not disposed inside the seat cushion frame 18.

Because of these, in the vehicle seat 10, there can be realized a configuration where the seat cushion 12 is switched between the seating position and the storage position by motive power (by just operating the switching switch 44) while making restrictions imparted to the function (mainly the seating function) of the seat cushion 12 as a seat and its structure and appearance fewer. Further, there is no motive power transmission mechanism because the drive motor 42 directly drives the drive shaft 30, so such a mechanism is not exposed in the process of changing the configuration of the seat cushion 12, and the seat has a good appearance (a measure to make the seat appear nice is unnecessary). Moreover, the drive motor 42 is disposed on the vehicle width direction outside portion of the back of the seat cushion 12, so the drive motor 42 does not end up being exposed to the side of the seat cushion 12 and, because of this also, a good appearance is ensured.

Further, in the vehicle seat 10, the drive motor 42 is fixed to the vehicle body floor F, so there is realized a configuration where the drive motor 42 is always connected to the drive shaft 30. For this reason, an operation such as the vehicle occupant latching, at the time of storage, a motive power transmission member (a hook-equipped belt, etc.) that hinders seating to the seat cushion 12 like in a configuration where the drive motor 42 is disposed on the roof, for example, becomes unnecessary.

Moreover, in the vehicle seat 10, the driven shaft 26 (the front hinge 22) and the drive shaft 30 (the rear hinge 24) are divided in the vehicle body front-rear direction, so there is nothing between the driven shaft 26 and the drive shaft 30 to interfere in the switching operation of the seat cushion 12 between the seating position and the storage position. For this reason, restrictions that the structure supporting the seat cushion 12 so that it may freely rotate with respect to the vehicle body imparts to the seating performance and structure of the seat cushion 12 can also be made fewer.

Moreover still, in the vehicle seat 10, the drive motor 42 is integrated with the rear hinge bracket 32 and attached to the base bracket 34, so the seat cushion 12, the front hinge 22 (the driven shaft 26 and the front hinge bracket 28), the rear hinge 24 (the drive shaft 30 and the rear hinge bracket 32), the base bracket 34 and the drive motor 42 can be made into an assembly before mounting to the vehicle. Because of this, in the vehicle seat 10, vehicle mountability is fine even while the seat is equipped with a motive power storage mechanism.

In this manner, in the vehicle seat 10 according to the first embodiment, there are few restrictions with respect to seat function, and the vehicle seat 10 can be switched from the seating position to the storage position by motive power.

Next, other embodiments of the present invention will be described, It will be noted that, in regard to parts and portions that are basically the same as those in the first embodiment or in preceding configurations, reference numerals that are the same as those in the first embodiment or in preceding configurations will be given thereto and description thereof will be omitted.

### Second Embodiment

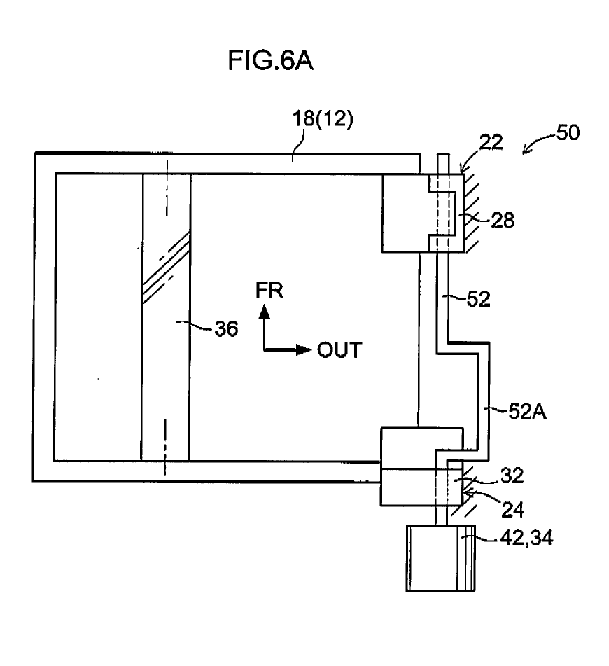

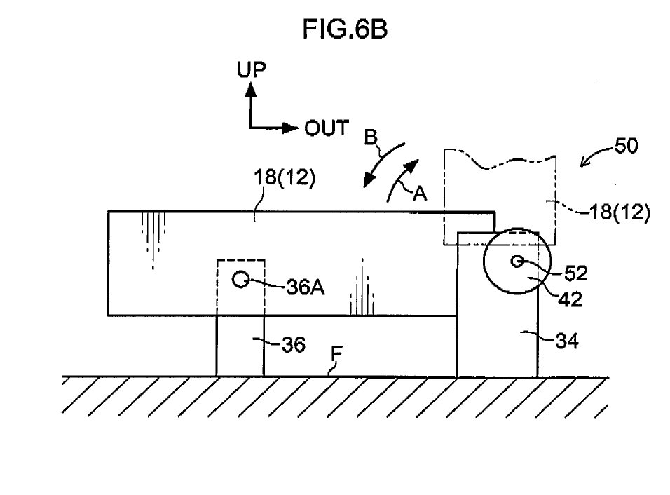

In FIG. 6(A), a vehicle seat 50 according to a second embodiment of the present invention is shown in a schematic plan view that corresponds to FIG. 5(A), and in FIG. 6(B), the vehicle seat 50 is shown in a schematic rear view that corresponds to FIG. 5(B). As shown in these drawings, the vehicle seat 50 differs from the vehicle seat 10 according to the first embodiment in that the front hinge 22 and the rear hinge 24 are equipped with a common rotation shaft 52 instead of the driven shaft 26 and the drive shaft 30.

An intermediate portion of the rotation shaft 52 in the front-rear direction is configured as an escape portion 52A that projects outward in the vehicle width direction, and the rotation shaft 52 is given a configuration where interference with something else (the vehicle seat 50 itself or the vehicle body side portion) that accompanies the change in configuration between the seating position and the storage position is prevented. The other configurations of the vehicle seat 50 are the same as the corresponding configurations in the vehicle seat 10.

Consequently, according to the vehicle seat 50 according to the second embodiment also, the same effects can be obtained by the same operation as the vehicle seat 10 according to the first embodiment.

### Third Embodiment

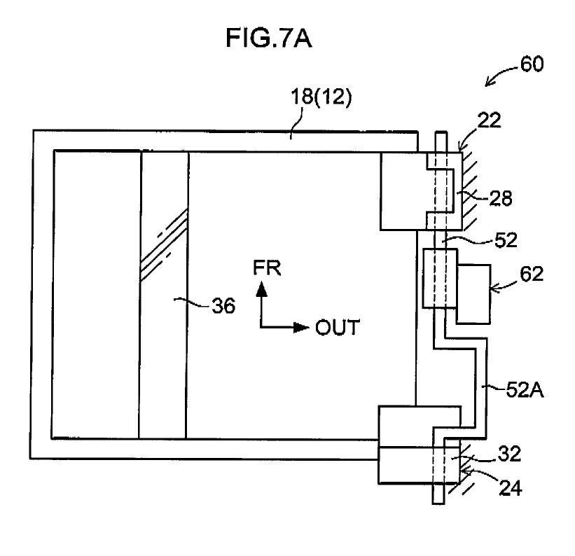

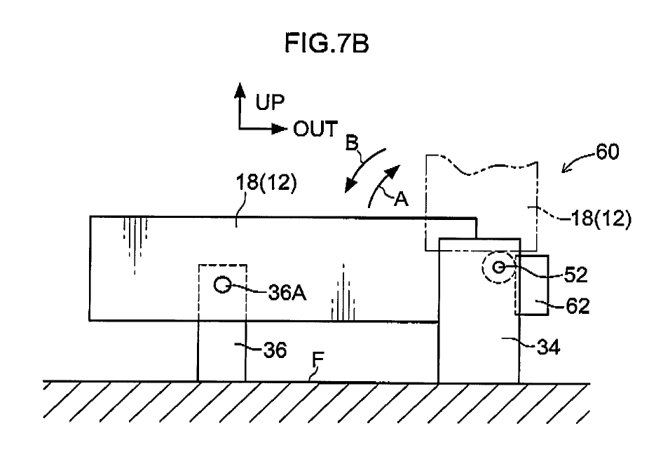

In FIG. 7(A), a vehicle seat 60 according to a third embodiment of the present invention is shown in a schematic plan view that corresponds to FIG. 5(A), and in FIG. 7(B), the vehicle seat 60 is shown in a schematic rear view that corresponds to FIG. 5(B). As shown in these drawings, the vehicle seat 60 differs from the vehicle seat 50 according to the second embodiment in that the vehicle seat 60 comprises a drive motor 62 that is disposed on the vehicle width direction outside of the front-rear direction intermediate portion of the seat cushion 12 instead of the drive motor 42 that is disposed behind the seat cushion 12.

The drive motor 62 is configured to directly drive the portion of the rotation shaft 52 between the front hinge 22 and the rear hinge 24 (in this embodiment, the portion in front the escape portion 52A) to rotate in the direction of arrow A or in the direction of arrow B. The drive motor 62 is fixed to the vehicle floor F or the vehicle cabin inside surface S via an unillustrated bracket. The other configurations of the vehicle seat 60 are the same as the corresponding configurations in the vehicle seat 50 according to the second embodiment.

Consequently, according to the vehicle seat 50 according to the third embodiment also, the same effects can be obtained by the same operation as the vehicle seat 10 according to the first embodiment, excluding effects resulting from the drive motor 42 being disposed behind the seat cushion 12.

It will be noted that, although an example where the drive motor 62 drives the rotation shaft 52 has been described in the third embodiment, the present invention is not limited to this and may also be configured such that, for example, the drive motor 62 drives the driven shaft 26 or the drive shaft 30.

### Fourth Embodiment

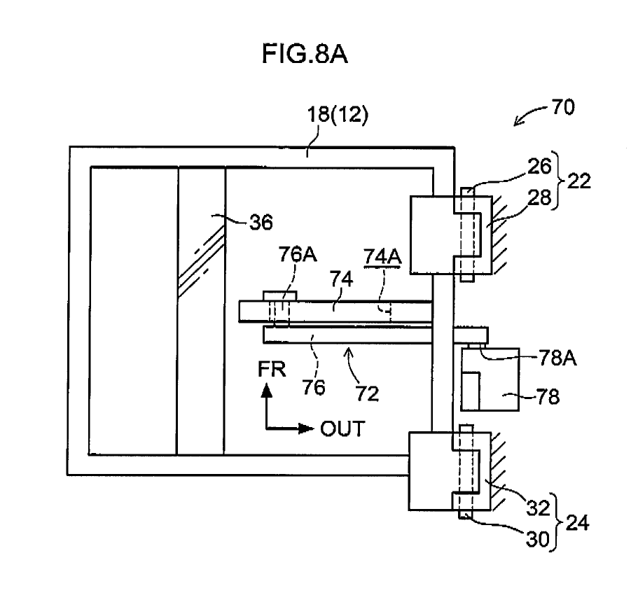

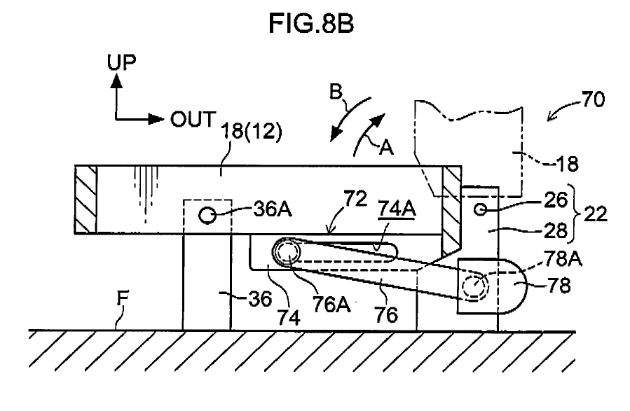

In FIG. 8(A), a vehicle seat 70 according to a fourth embodiment of the present invention is shown in a schematic plan view that corresponds to FIG. 5(A), and in FIG. 8(B), the vehicle seat 70 is shown in a schematic rear view where the seat cushion frame 18 is partially cutaway. As shown in these drawings, the vehicle seat 70 differs from the vehicle seat 10 according to the first embodiment in that the vehicle seat 70 comprises a drive mechanism 72 that applies drive force in the direction of arrow A or arrow B to the seat cushion frame 18 instead of the drive motor 42 that directly drives the drive shaft 30. It will be noted that, in the description below, the shaft represented by reference numeral 30 that configures the rear hinge 24 will be called a rotation shaft 30.

The drive mechanism 72 is configured to include a slider link 74 that has a slit 74A whose longitudinal direction is in the vehicle width direction and which is fixed to the seat cushion frame 18, a drive link (arm) 76 having one end that is connected to, so as to be slidable and relatively rotatable in, the slit 74A via a link pin 76A, and a drive motor 78 that drives the other end portion of the drive link 76 to rotate in the direction of arrow A or in the direction of arrow B. An output shaft 78A (center of rotation) of the drive motor 78 fixed to the vehicle body floor F via an unillustrated bracket is disposed away from the rotation shaft 30. Further, in this embodiment, the drive motor 78 is disposed on the vehicle width direction outside portion of the vehicle body front-rear direction intermediate portion of the seat cushion 12.

As a result, the vehicle seat 70 is provide with a configuration where, when the drive motor 78 is activated and the drive link 76 rotates in the direction of arrow A about the output shaft 78A, the drive link 76 pushes the slider link 74 in the direction of arrow A while sliding in the slit 74A via the link pin 76A, whereby the seat cushion frame 18 rotates in the direction of arrow A about the driven shaft 26 and the rotation shaft 30 and switches from the seating position to the storage position. Further, the seat cushion frame 18 is switched from the storage position to the seating position by substantially the opposite operation of this.

The other configurations of the vehicle seat 70 are the same as the corresponding configurations in the vehicle seat 10 according to the first embodiment.

Consequently, in the vehicle seat 70 according to the fourth embodiment, the same effects can be obtained by the same operation as the vehicle seat 10 according to the first embodiment, excluding effects resulting from the drive motor 42 directly driving the drive shaft 30 and effects resulting from the drive motor 42 being disposed behind the seat cushion 12.

### Fifth Embodiment

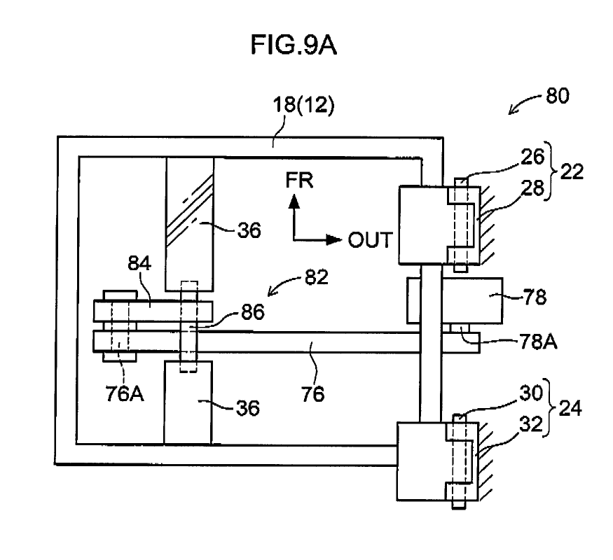

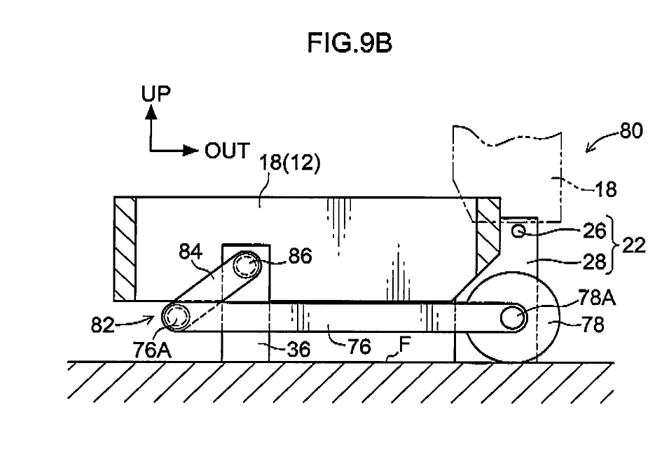

In FIG. 9(A), a vehicle seat 80 according to a fifth embodiment of the present invention is shown in a schematic plan view that corresponds to FIG. 5(A), and in FIG. 9(B), the vehicle seat 80 is shown in a schematic rear view where the seat cushion frame 18 is partially cutaway. As shown in these drawings, the vehicle seat 80 differs from the vehicle seat 70 according to the fourth embodiment in that the vehicle seat 80 comprises a drive mechanism 82 that is a quadric crank chain mechanism instead of the drive mechanism 72.

The drive mechanism 82 comprises a link 84 having one end that is connected, so as to be relatively rotatable, via the link pin 76A to one end portion of the drive link 76, and the other end of the link 84 is connected to the support leg 36 via a link shaft 86. The link shaft 86 is disposed coaxially with the support shaft of the support leg 36 with respect to the seat cushion frame 18. Consequently, the drive mechanism 82 configures quadric crank chain with the vehicle body (the link that interlinks the rotation shaft 30 and the output shaft 78A of the drive motor 78) that is a fixed link, the drive link 76, the link 84 and the seat cushion frame 18. It will be noted that, in this embodiment, the support leg 36 is divided in two into front and back legs.

Because of the above, the vehicle seat 80 is given a configuration where, when the drive motor 78 is activated and the drive link 76 rotates in the direction of arrow A about the output shaft 78A, the link 84 pushes the seat cushion frame 18 (the link shaft 86) in the direction of arrow A while changing its configuration with respect to the drive link 76, whereby the seat cushion frame 18 rotates in the direction of arrow A about the driven shaft 26 and the rotation shaft 30 and switches from the seating position to the storage position. Further, the seat cushion frame 18 is switched from the storage position to the seating position by substantially the opposite operation of this.

The other configurations of the vehicle seat 80 are the same as the corresponding configurations in the vehicle seat 10 according to the first embodiment.

Consequently, in the vehicle seat 80 according to the fifth embodiment, the same effects can be obtained by the same operation as the vehicle seat 10 according to the first embodiment, excluding effects resulting from the drive motor 42 directly driving the drive shaft 30 and effects resulting from the drive motor 42 being disposed behind the seat cushion 12.

### Sixth Embodiment

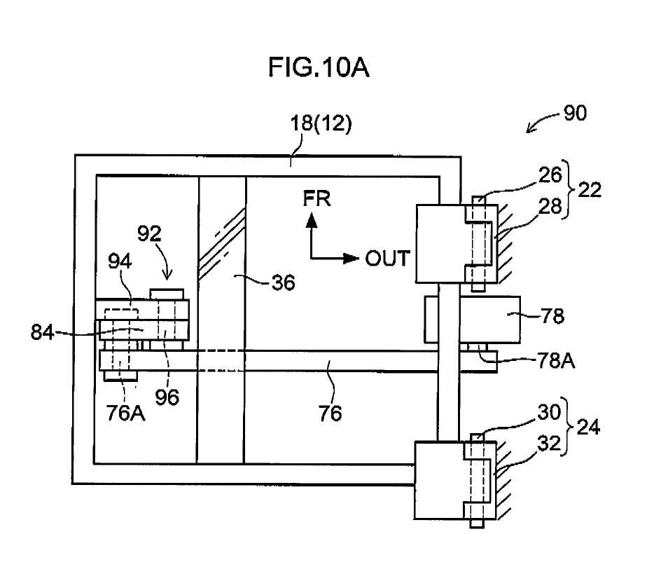

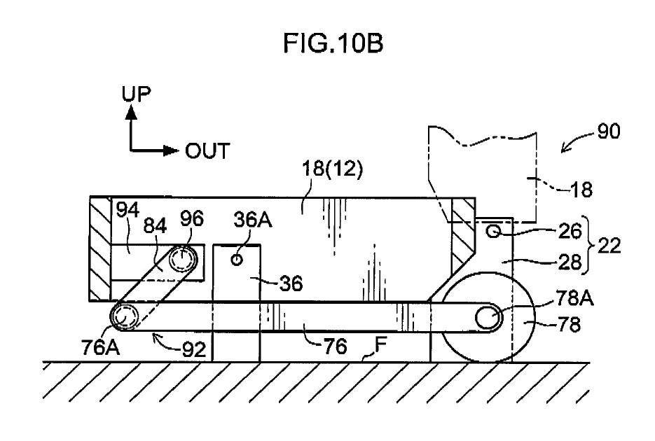

In FIG. 10(A), a vehicle seat 90 according to a sixth embodiment of the present invention is shown in a schematic plan view that corresponds to FIG. 5(A), and in FIG. 10(B), the vehicle seat 90 is shown in a schematic rear view where the seat cushion frame 18 is partially cutaway. As shown in these drawings, the vehicle seat 90 differs from the vehicle seat 80 according to the fifth embodiment in that the vehicle seat 90 comprises a drive mechanism 92 instead of the drive mechanism 82.

The drive mechanism 92 comprises a link plate 94 that projects outward in the vehicle width direction from the vehicle width direction inner end portion of the seat cushion frame 18, and the other end portion of the link 84 is connected, so as to be relatively rotatable, to the link plate 94 via a link pin 96. Because of this, the drive mechanism 92 configures, like the drive mechanism 82, quadric crank chain with the vehicle body that is a fixed link, the drive link 76, the link 84 and the seat cushion frame 18, The other configurations of the vehicle seat 90 are the same as the corresponding configurations in the vehicle seat 80 according to the fifth embodiment.

Consequently, in the vehicle seat 90 according to the sixth embodiment, the same effects can be obtained by the same operation as the vehicle seat 10 according to the first embodiment, excluding effects resulting from the drive motor 42 directly driving the drive shaft 30 and effects resulting from the drive motor 42 being disposed behind the seat cushion 12.

### Reference Example

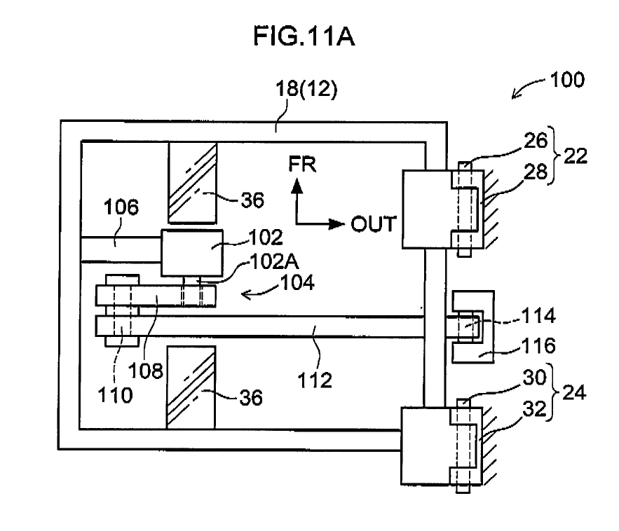

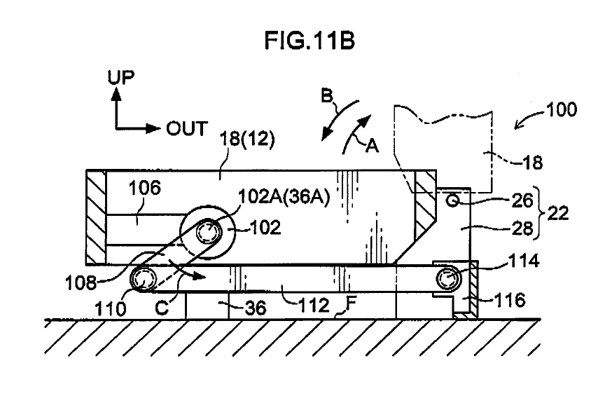

In FIG. 11(A), a vehicle seat 100 according to a reference example that is not included in the present invention is shown in a schematic plan view that corresponds to FIG. 5(A), and in FIG. 11(B), the vehicle seat 100 is shown in a schematic rear view where the seat cushion frame 18 is partially cutaway. As shown in these drawings, the vehicle seat 100 differs from each of the embodiments of the present invention in that the vehicle seat 100 comprises a drive mechanism 104 including a drive motor 102 that is fixedly supported in the seat cushion frame 18. The drive motor 102 is held in the vehicle width direction inside portion of the inside of the seat cushion frame 18 via a motor support bracket 106. In the present reference example, the drive motor 102 is disposed between the support legs 36 that are divided in two into front and back legs.

The drive mechanism 104 is configured to include a drive link 108 having one end that is fixed to, so as to rotate integrally with, an output shaft 102A of the drive motor 102, a link 112 having one end that is connected, so as to be relatively rotatable, via a link pin 110 to the other end of the drive link 108, and a bracket 116 that supports the other end of the link 112 via a link pin 114 such that the link 112 is relatively rotatable and which is fixed to the vehicle body floor F. The link pin 114 is disposed away from the rotation shaft 30. Consequently, the drive mechanism 104 configures quadric crank chain with the vehicle body (the link that interlinks the rotation shaft 30 and the link pin 114) that is a fixed link, the drive link 108, the link 112 and the seat cushion frame 18.

Because of the above, the vehicle seat 100 is given a configuration where, when the drive motor 102 is activated and the drive link 108 rotates in the direction of arrow C about the output shaft 102A, the seat cushion frame 18 rotates in the direction of arrow A about the driven shaft 26 and the rotation shaft 30 and switches from the seating position to the storage position. Further, the seat cushion frame 18 is switched from the storage position to the seating position by substantially the opposite operation of this.

It will be noted that, in each of the preceding embodiments and in the reference example, an example has been described where the vehicle seat 10 assumes the storage position in a state where the seat back 14 is folded up on the seat cushion 12, but the present invention is not limited to this; for example, the vehicle seat 10 may also be stored along the vehicle cabin inside surface S in a state where the seat back 14 is reclined back so as to form a substantially even surface with the seat cushion 12.

### EXPLANATION OF THE REFERENCE NUMERALS

10 Vehicle seat (Vehicle seat device)
12 Seat Cushion
26 Driven Shaft (Rotation shaft)
30 Drive Shaft (Rotation shaft)
32 Rear Hinge Bracket (Support Member)
34 Base Bracket (Support Member)
42 Drive Motor (Drive Source, Driving means)
50, 60, 70, 80, 90 Vehicle seats (Vehicle seat devices)
52 Rotation shaft
62 Drive Motor (Drive Source, Driving means)
72, 82, 92 Drive Mechanisms (Driving means)
78 Drive Motor (Drive Source)

1. A vehicle seat device comprising:
a seat cushion that is supported so as to be rotatable about a rotation shaft having an axis along a vehicle body front-rear direction at a vehicle width direction outer side end portion thereof, and which can be switched between a seating position at which an occupant can be seated and a storage position at which the seat cushion stands erect along a vehicle body inner surface, due to rotation around the rotation shaft; and
a driving device including a drive source that is fixed to a vehicle body vertical direction lower portion of the vehicle body at an installation side of the rotation shaft with respect to a vehicle width direction center portion of the seat cushion, the driving device switching the seat cushion between the seating position and the storage position by activation of the drive source.

2. The vehicle seat device according to claim 1, wherein:
the rotation shaft is provided so as to rotate integrally with the seat cushion; and
the driving device includes an output shaft that is connected to the rotation shaft so as to rotate integrally with the rotation shaft when the output shaft is rotated by activation of the drive source.

3. The vehicle seat device according to claim 2, wherein the drive source is disposed behind the seat cushion in the vehicle body front-rear direction.

4. The vehicle seat device according to claim 3, wherein the drive source is fixed to a support member that is fixed to a vehicle body floor and supports the rotation shaft or the output shaft such that it is able to freely rotate with respect to the vehicle body.

5. The vehicle seat device according to claim 1, wherein a portion of the rotation shaft that supports the vehicle body front-rear direction front side of the seat cushion and a portion of the rotation shaft that supports the vehicle body front-rear direction rear side of the seat cushion are separated in the vehicle body front-rear direction.
